(19) United States
(12) Patent Application Publication
(10) Pub. No.: US 2021/0182807 A1
(43) Pub. Date: Jun. 17, 2021

(54) Soft Mining Device and Methods for Digital Currency Coins

(71) Applicants: Peter Akuon, Nairobi (KE); Andrew Kimani, Nairobi (KE)

(72) Inventors: Peter Akuon, Nairobi (KE); Andrew Kimani, Nairobi (KE)

(21) Appl. No.: 16/769,249

(22) PCT Filed: Apr. 9, 2018
(86) PCT No.: PCT/IB2018/052461

§ 371 Date: Jun. 3, 2020

(30) Foreign Application Priority Data
Dec. 5, 2017 (KE) KE/P/2017/002761
Dec. 5, 2017 (KE) KKE/P/2017/002762

(51) Int. Cl. G06Q 20/06; G06F 16/27; H04L 9/32

(52) U.S. Cl. CPC G06Q 20/0658; H04L 2209/38; H04L 9/3239; G06F 16/27

(57) ABSTRACT

A decentralized device is provided for the execution of verified coins as mined by subscribers in a network for communications. The mining method relates to active use of handset or a group thereof and utilization of communication system resources, which is used to generate participation units that are then converted into multiple levels of digital currency in the form of a coin, where the conversion is based on stabilized network tariffs that are derived from value of gold. These multi-layer digital currency coins are traded as securities.

### CROSS-REFERENCE TO RELATED APPLICATIONS

This application claims priority to PCT/IB2018/052461, filed 9 Apr. 2018, which PCT application claims priority to provisional applications KE/P/2017/002761, filed 5th December 2017 and entitled “Mining Method for Digital Currency” and KE/P/2017/002762, filed 5th December 2017 and entitled “Soft Mining for Digital Bit Currency”, the entire contents of which are incorporated herein by reference.

### TECHNICAL FIELD

The present disclosure relates generally to applications, systems, and methods for exchange in financial markets using records in decentralized intelligent machines in a complex peer-to-machine and peer-to-peer communications network.

### BACKGROUND

Conventional securities can be classified in terms of shares, bonds or participation units. These securities confer rights owned by individuals and they can be used for payments beyond the initial value and they don't have to be controlled by a cohesive party e.g. a start-up firm. However, recently, digital currencies have been classified as securities and these digital currencies have been generated in different ways.

A common form of digital currency is a loyalty scheme, where spenders of fiat money on goods and services are rewarded with loyalty points, which can be used for exchange of goods and/or services.

In addition, there have been well-known cryptographic currencies which are a form of a digital medium of exchange that enable fast, decentralized, peer-to-peer and cryptographically secure transactions for goods, services or both.

For example, Bitcoin uses addresses and public key cryptography algorithm which help in providing how to regulate its issue, defeat counterfeiting and double-spending as well as safe without relying on a single authority. These algorithms are generally referred to as secure hash algorithms (SHA) as developed by the US space agency (NASA). Such algorithms like elliptic curve digital signature algorithm (ECDSA) depend on ‘proof-of-work’ (POW) principle to enable exchange of value by making a chain of activity logs in a network of peer processors being very difficult to realize.

The process of computing these digital crypto-currency coins is referred to as mining. Normally central processing units (CPU), graphic processing units (GPU), field programmable gate-array (FPGA) and application-specific integrated circuits (ASIC) are used for processing the difficulties in such a block-chain.

In essence, the cost of crypto-currency mining consists of the amount of electricity consumed, which is then used to compute the presented difficulties in a network using a hardware processor or a pool of them. However, issues have come up concerning definition of Bitcoin as to whether it is a virtual currency, a crypto-graphical protocol, financial instrument or something else.

Other methods of mining involve the use of scrypts, which are password-based key derivation functions. For example Litecoin is produced through scrypts.

When a coin is mined in the network, it is stored in a digital wallet, which is normally secured offline.

Through peer-to-peer internet network, certain quantities of digital currencies (e.g. 7 bitcoins) can be sold in place of goods or/and services, purchased at an exchange, traded or exchanged for a different currency.

On the first part, a weakness of loyalty points occurs due to the fact that the fiat value is determined by the recipient of payments, which is not decentralized and as a result, loyalty points is not a competitive candidate for securities.

In addition, the following weaknesses have also been cited in crypto-graphic currencies: Firstly, it is hard to directly identify users since they are identified through addresses in the network thus the users generally remain anonymous.

Secondly, encryption protocols are prone to time-jacking i.e. an attacker may alter the time counter since the mining process is competitive in the sense that a specific hash code is mined by all subscribers in the network. That is, both mining and approval processes are carried out simultaneously. In addition, double-spending attacks where a user sends coins to many merchants at the same time.

Thirdly, users with more than 50% network capacity can generate coins faster than anyone else in the network. Furthermore, the ability to use renewable energy lowers the competitiveness of mining. Majority attack may occur due to consensus mechanism i.e. a group of miners collectively builds a great hashing power so as to control the network. This way, miners will be able to double spend their transactions and be able to remove previously validated blocks from the chain and ban some transactions from the block-chain.

In addition, money laundering and counterfeiting is more dangerous in crypto-currency than in fiat money (fiat being a legal tender that is not necessarily backed by a physical commodity) since a network of high-speed processors are used in the network, without know-your-customer (KYC) requirements.

Indeed, a system is required to solve these problems of the prior art for mining digital coins. The method of the present invention proposes to provide a new method of mining digital currency derived from individual fiat money and time expended to maintain a connection in a mining network by a registered subscriber or bills plus network and hardware resources consumed.

Instead of ‘proof of work’ concept, the present invention relies on ‘proof of stake’, which is a rare and difficult/expensive activity on the performed by an individual subscriber on a secure and de-centralized coin verification device network of an operator.

This sort of invention rides on participation unit as a mode of mining. Since billing/charging process at the network level is known to be highly secure, subscribers are not anonymous and no time counters can be altered by subscribers, and mining process is independent of the approval process for the already mind coins, this method solves several weaknesses of the prior art. The computationally complex devices are not a necessary requirement and cheap subscriber devices are used.

In fact, there are many network service providers that provide the billing information from their intelligent networks and each subscriber mines digital coins based on their consumption of network and hardware resources.

### SUMMARY OF INVENTION

According to one broad aspect of the present invention, a coin is generated or mined based on direct network connectivity charges which are deducted or deductible from a subscriber's identity module (SIM) account.

According to one broad aspect of the present invention, coins are generated based on billing information in terms of the amount of airtime consumed, which is dependent on the call duration or duration of data connectivity.

According to one broad aspect of the present invention, coins are generated based on the number of network resources utilized in making a call or data connection e.g. distance between origin of call and destination of call dictates the number of BTS, BSC and radio station antennas utilized during the call. The more the network resources are used, the less the number of coins generated or otherwise.

According to one broad aspect of the present invention, minimum distance of connection is taken to be within and including 30 km within a single communications cell or a specified radius size.

According to one broad aspect of the present invention, coins are generated based on the minimum number of billed connections that are set up by a subscriber in a day.

According to one broad aspect of the present invention, coins are generated based on total number of billed or charged connections set up in a day.

According to one broad aspect of the present invention, coins are generated based on total number of uses of the hardware module e.g. taking photos or images, watching movies or operating the hardware module.

In some embodiments, the coins so generated are referred to as Layer type-A coins.

In some embodiments, Layer type-A coins are used in a global communications network to generate Layer type-B coins.

In some embodiments, Layer type-B coins are mined by validating a nonce code value of a block-chain based on the number of Layer type-A coins and a subscriber whose subscriber node generates the valid nonce code is rewarded with a Layer type-B coin.

In some embodiments, Layer type-B coins are mined by a nonce code value while utilizing application software installed in the subscriber node or mobile station.

In some embodiments, transaction logs are kept as ledgers by a network's distributed database devices.

In some embodiments, these coins are exchanged for goods and/or services, or these coins are sold to other registered users or these coins are bought from other registered users.

In some embodiments, the coins are stored in a digital wallet in an exchange device, which is reachable by the owner, who is a subscriber to that mining network provider.

In some embodiments, apart from newly generated coins, any other instruction that is meant to securely manipulate the number of coins is issued only by the owner of the digital wallet, who is the registered subscriber.

### BRIEF DESCRIPTION OF THE DRAWINGS

The invention will be explained in more detail in the following text using one exemplary embodiment and with reference to the drawings, in which

FIG. 1 shows a block diagram illustrating apparatuses in a communications system

FIG. 2 shows a block diagram illustrating mining and storage devices for ComApp Coins.

FIG. 3 shows a flow chart illustrating verifying methods by an agent device for ComApp Coins.

### DETAILED DESCRIPTION OF EMBODIMENTS

It is an aim of the invention to overcome the weaknesses of the prior art in mining digital currency.

The present invention relies on novel concepts of communication. Initial Coin Offering (ICO) usually states what the project is about, the need(s) the project intends to fulfill upon completion, how much money is required to undertake the project, how much of the coin tokens the pioneers of the project will keep for themselves, what the type of money that is accepted and the duration of the ICO campaign.

An initial coin offer value may be set according to difficulty met by subscriber community in generating the coins. Difficulty refers to the average ratio of coins generated by subscribers of communications service providers and the fiat money plus network and hardware resources utilized to acquire call data connection or hardware storage utilization.

These coins are stored in a digital wallet, which is reachable only by the subscriber in a decentralized database system consisting of distributed agent nodes for verification of coins or ratification. The owner, who is a subscriber of the network indeed, has both ownership and administrative access.

The network airtime is consumed through connection services in terms of voice, short messaging services, storage, usage of hardware terminal, data and video services.

In one step, coins are generated based on the billing information in terms of the amount of airtime consumed, which is based on the call duration.

In another step, coins are generated based on the number of network resources utilized in making a call or data connection e.g. the distance between the origin and destination of calls dictates the number of base station transceivers (BTS), base station controller (BSC) and radio station antennas utilized during the call.

In another step, coins are generated based on the number of billed/chargeable connections set up in a day.

To this end, the present invention is synonymous with a recent invention of digital currency as referenced in this disclosure (and now combined in the present disclosure) that is generated by individual subscribers through a class of peer-to-machine mining methods. The coin id derived from the cost of utilization of network only.

However, ‘proof-of-authority’ for such a coin rests with the account holder as maintained by the network server in a non-decentralized manner and fluctuations in prices may affect the coin value.

There is need to solve the problem of such a coin in order to introduce decentralized ‘proof-of-authority’ and provide additional mining holes or sources.

As a result, in the present invention, additional mining difficulties are implemented such that different layers consisting of peer-to-peer and peer-to-machine mining steps are utilized in the mining process.

In terms of network mining, a tariff for the coins is calculated based on an algorithm that comprises the price of gold and the amount of expenditure on the hardware and network resources. For example:

1 ounce of gold is equivalent to 31.19 g of gold, whereas 1 gram measure of gold is taken to be 15.43 grains (gr) of gold.

Pure gold is given to be 24 karat gold grade, finest quality raw and solid volume, which is denoted as pure 24K gold, with Density: 19.282 gcm³.

Number of participation points generated per subscriber, p_{#} is derived as follows

$${p}_{\#} = 〈 \frac{{∈}_{v k} ( k ) + {∈}_{v m} ( t - k ) + \frac{{∈}_{v t}}{r}}{{f}_{m}} 〉 \qquad ( 1 )$$

where ∈ᵥₖ is a subscriber-average expenditure on communication services for the first k calls,

∈ᵥₘ is a subscriber-average expenditure on communication services for all calls minus that of the first k calls,

r is a resource regime ratio of network resources utilized every 30 km radius from the destination e.g. rᵢ=1 if subscriber is within 30 km from the destination and rᵢ=2 within 60 km but beyond 30 km from the destination,

∈ᵥₜ is a subscriber-average expenditure on communication services for all the t calls,

$${∈}_{v r} = \frac{{∈}_{vt}}{r}$$

is a subscriber-average expenditure on communication services for calls in the region of the origin and destination i.e.

$$r = \frac{{\sum }_{i}^{t} {r}_{i}}{t} \qquad ( 2 )$$

fₘ is the fiat money value proposed for the application software in the network home.

For example, the number of network coins generated per subscriber, C_{#N} in the nth year is derived as follows:

$$\begin{matrix}{C}_{\# N} = \frac{〈 {p}_{\#} 〉 {f}_{m}}{{C}_{c G} + ( n - 1 ) {I}_{cG}} \\ = 〈 \frac{{∈}_{v k} ( k ) + {∈}_{v m} ( t - k ) + \frac{{∈}_{v t}}{r}}{{C}_{c G} + ( n - 1 ) {I}_{c G}} 〉\end{matrix} \qquad ( 3 )$$

C_{CG} is the present cost of 4 grains of 24K pure gold,
n is the year of interest from the present year,
I_{nG} is the annual increase in the cost of 4 grains of 24K pure gold.

The price for gold appreciates constantly every year, and the spending in the communications sector is expected to follow the same growth. This phenomenon where coin value follows appreciation in gold value guards the proposed method and digital currency coins against inflation.

The distance between the origin and the destination for data connectivity is taken to be within 30 km. However, if the destination is a voice-called party, whether through data i.e. voice over internet protocol (VoIP) or circuit switched, the distance between the origin and destination is computed as the distance between the serving network cells or sectors within the cells of the radio access zone. The distances are expressed in kilometers and converted into regions denoted as r₁.

In the case of hardware mining, the following processes are monitored and constituted into the number of coins mined as additional sources or mining holes: peak processing power of a radio communicating device, peak processor speed, duration of hardware activity and percentage of memory space utilized in a subscribers hardware. These factors are used to derive an additional tariff and to generate a number of hardware coins, C_{#H}. The total number of coins C_{#T} is given as the sum of network and hardware coins which is expressed as:

C_{#T}=(C_{#N}+C_{#H}) (4)

The total coins value is derived from C_{#T} and then converted by the application in the subscriber device into a nonce code, which is valid only once. The nonce code is submitted for approval to the network's distributed database through agent devices of the present invention.

Three mining classes are proposed in the present invention. The usage of network hardware module only is classified as off-line utilization mining for layer A coins. Here, an application that is installed in the hardware monitors hardware usage such as taking photos, watching movies, charging of phone e.t.c. Furthermore, the following processes are monitored and constituted into the number of coins mined as additional sources or mining holes: peak processing power of a radio communicating device, peak processor speed, and duration of hardware activity and percentage of memory space utilized in the hardware module.

The usage of network hardware resources, hardware terminal and network services is classified under on-line utilization mining for layer A coins.

The usage of network hardware resources, hardware terminal, network services and distributed agent device is classified under hybrid mining for both layer A and layer B coins.

For example, expenditure of money and time on network services, number of services and types of services (voice mail, sms, calls, data, internet access) accessed, and distance between calling and called party are used to generate layer type-A of digital currency coins. However, these Layer type-A coins are then used to generate additional layer type-B digital currency coins i.e. ComAppCoin.

In addition, “proof-of-authority” is decentralized into a post-mining public network in order to verify the validity of the coins as mined by individual miners through agent devices.

In the present invention a communication network operator (e.g. mobile network operator) does not authorize the number of coins earned, and an application platform is installed into hardware device to monitor processes, which are then sent into a public network for verification by network agents and storage into a distributed database as controlled by a transaction server device for trading purposes.

E.g. in conventional mining, there is no mandatory supervision of individual miners inside mining holes, but the minerals are normally verified through agreed standards and measures for each type of mineral.

Layer type-B digital coin currencies are mined in the following ways.

In the first place, a specified number of layer type-A coins can be converted into layer type-B coins.

Secondly, network verifying agent devices also earn layer type-B coins based on the number of records or ledgers of coins from subscriber devices that they have verified in the network.

Thirdly, a registered subscriber may buy layer type-B coins directly from an exchange point as described in the present invention.

An application installed in a subscribers hardware sends out a nonce code into the network based on the number of coins mined. The nonce code is then ratified in a block-chain in a global network by participating agent devices. A validated nonce code is then sent to a network transaction server device and the subscriber device that submits the valid nonce code is rewarded with corresponding number of layer type-A coins. The validating agent devices are rewarded with layer type-B coins based on a specified number of validated transaction ledgers or records.

Submission period for each valid nonce code is regulated by an application that is installed on each subscriber device node. It is this application at the subscriber node that is referred to as a soft computer, hence soft mining. The application may be in the form of a computer instruction software or sim tool kit or reachable through unstructured subscriber service dialing (USSD) code.

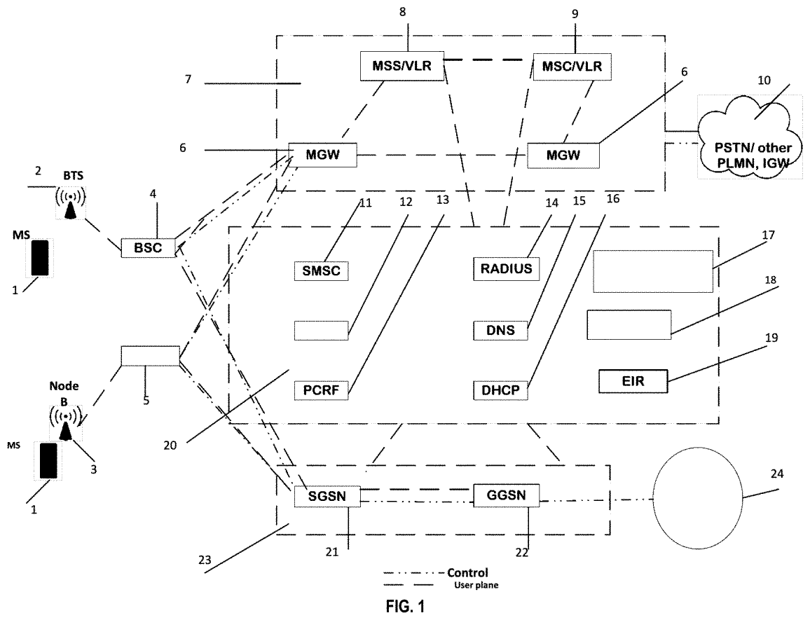

And now with reference to the figures. FIG. 1 illustrates an apparatus of a communications system, where a subscriber who uses a mobile station (1) equipment in a GSM/2G or 3G network connects to data network for internet (24) or calls another subscriber on another mobile station. The subscriber may utilize 2G network components like a base transceiver station (BTS) (2) which connects to Base Station Controller (BSC) (4) or the subscriber may connect through 3G network Node B-Base Station Transceiver for 3G (3) which connects to RNC—Radio Network Controller (5). A call in 2G network is routed through a MGW—Media Gateway (6) where Circuit Core Domain Processes (7) take place. In (7), switching is performed by MSS—Mobile Soft Switch (8) or MSC—Mobile Switching Center (9).

A VLR—Visitor Location Register (8,9) is used to store information of visitors to the network. In addition, (7) enables communication with other service provider networks such as IGW—International Gateway (10), PSTN—Public Switched Telephone Network (10), PLMN—Public Land Mobile Network (10).

Also, services such as short messages are stored in SMSC—Short Messaging Service Center (11) and details of subscribers are stored in HLR—Home Location Register (12).

PCRF—Policy and Charging Rules Function (13) supports service data flow detection, enforcement of policy and flow-based charging. It easens alignment of revenue and resources in the network.

Authentication of network subscribers is achieved through RADIUS—Remote Authentication Dial-in User Service (14) server in the authentication center (AuC). A digital wallet in the network registers transactions of call connectivity activities, participation points and digital currency coins. Any management of the digital wallet requires authentication and the passwords are stored off-line by the subscriber. The RADIUS (14) server manages such transaction logs and verifications. The DNS—Domain Name Server (15) that utilizes DHCP—Dynamic Host Control Protocol (16).

Billing or charging information is stored in Billing Charging center (17) while the network maintenance is performed via NMS/OSS—Network Management System/Operation Support SubSystem (18). Moreover, details of hardware addresses that are used in the network are verified, allowed or denied through EIR—Equipment Identity Register (19). These services are managed through Service and Subscriber Management System (20).

When a user connects to data network through general packet radio service (GPRS), the MS (1) connects to a SGSN—Serving GPRS Support Node (21), which is in turn connected to GGSN—Gateway GPRS Support Node (22) in a region of Packet Core Domain Processes (23) and Internet (24).

Generally, the MS (1) carries a SIM—Subscriber Identity Module, which is the register for IMSI—International Mobile Subscriber Identity in (1) and helps to communicate IMEI—International Mobile Equipment Identity in (1) to the network's EIR (19). The IMEI may be used to block certain types of equipment from accessing the network if they are unsuitable and also to check for stolen equipment.

The SIM and HLR (12) also stores TIMSI—Temporary—International Mobile Subscriber Identity in (17) and MS ISDN—Mobile Subscriber International Subscriber Dialling Number. The IMSI identifies the subscriber within the GSM network while the MS ISDN is the actual telephone number a caller uses to reach that person through the network. Security is provided by the use of an authentication key and by the transmission of a temporary subscriber identity (TMSI) across the radio interface where possible to avoid using the permanent IMSI identity. Other networks can be tied to the network of FIG. 1 for communication services. Such networks include: ISDN—Integrated Services Digital Network, PSPDN—Packet Switched Public Data Network and CSPDN—Circuit Switched Public Data Network.

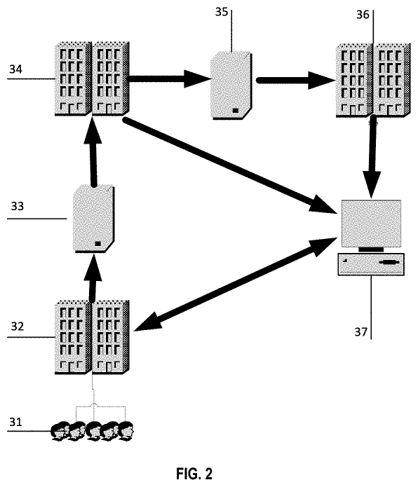

FIG. 2 shows a block diagram illustrating mining and storage devices for ComApp coins. Coin network subscribers register to a network through a sub device (31) and their profiles registered in the HLR of the coin network which is the same as a database within the server device (37). The profile for each subscriber consists of an identifier in the form of International Mobile Subscriber Identity (IMSI), International Mobile Equipment Identity (IMEI) and a private and public key for authorization into the network. An application is installed in (31) that submits mining status (number of coins mined) to the server device (37) through distributed verifying agent devices (32). The mining status is submitted in the form of a nonce code that consists of time-stamps. The nonce code consists of a first identifier for the sub device, a second identifier for coins mined from hardware mining process and a third identifier for coins mined based on network mining process.

In the coin mining procedure, the subscribers of the present disclosure install an application for ComApp coin in the hardware of the sub device (31), which monitors the utilization of network resources in one hand and utilization of hardware resources in the other hand.

Also, the time taken in a network session for data and voice calls are monitored by the application. The application also records the number of calls made, the duration of connection and computes distance between a calling party and a called party based on scaled time parameters.

The application in (31) then applies an appropriate tariff over utilization of the network and computes an average expenditure during network connectivity sessions. The process in which the application computes network session of a given subscriber module is referred to as network resource mining. It is emphasized that the present disclosure does not apply the tariffs of a mobile network operator (MNO) to compute the number of coins.

The application in (31) also applies an appropriate tariff over utilization of hardware resources. The process in which the application computes hardware use session of a given subscriber module is referred to as hardware resource mining.

The mining procedures are performed in mining hole A in (33). The number of coins generated from this mining process in hole A is stored in Layer type-A distributed database (34).

In one method, the number of coins in Layer type-A distributed database for each subscriber may be used in the mining process in mining hole B (35) to produce Layer type-B coins which are stored in Layer type-B distributed database (36).

In the trading procedure, both Layer type-A and Layer type-B coins are traded as commodity in an exchange system (37). However, the value of Layer type-B coins is initially higher than Layer type-A coins.

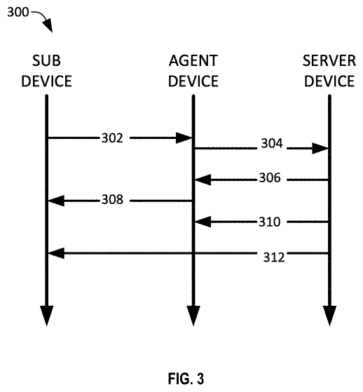

In the coin submission procedure, FIG. 3 shows a flow chart illustrating verifying methods by an agent device for ComApp Coins. An application installed in a subscriber device, here (300) referred to as a sub device submits (302) a nonce code to a distributed agent device. A nonce code is computed by an application installed in each subscriber terminal and the nonce code is forwarded to a distributed agent device for verification when the application in the subscriber module is on-net. When verified by an agent device, the nonce code enables a subscriber to earn corresponding layer type-A coins in the network. The verifying agent earns a layer type-B coin for corresponding number of verifications performed. The nonce code consists of a first identifier for the sub device, a second identifier for number of coins mined from hardware mining process and a third identifier for coins mined based on network mining process. The agent device then forwards (304) a verified nonce code consisting of sub device identifier and verified coin identifier of the nonce code to a server device for confirmation. The server device checks if the verified coin identifier for the sub device has been received from all or specified number of agent devices in the coin network. The server device then confirms (306) the validity of the verified identifier for sub device to the agent device, after which the agent device notifies (308) the sub device to wait as processing of the coins, is ongoing. The server device also notifies (310) the agent device on the number of Layer type-B coins earned by the agent device over that transaction. The server device then notifies (312) the sub device or a group of sub devices on the number of Layer type-A coins earned by the subscriber device over that transaction. New nonce codes are released from subscriber device into the network at pre-defined periods, one at a time. The notification is provided in the form of short messages. Delivery of such short messages may be supported through a secondary network of an MNO.

What has been described above includes examples of systems that may be covered by the disclosed invention. Anyone with ordinary skill in the art may perform or understand that other combinations of systems and methods may be used to produce similar disclosures. Therefore, little deviations from the teachings of the present invention do not change the inventive step of utilizing individually spent resources in a communication network and network modules to mine secure digital coins.

1. A device comprising a transactions processor; and a random access or read only memory that contains executable instructions to be executed by the processor to enable certain operations, comprising: receiving a first nonce code data from a subscriber device; and receiving a second nonce code data from a distributed database device, wherein the database nonce code data represents the first nonce code data and a second nonce code data, facilitating transfer of coins earned by the subscriber device to the distributed database devices.

2. The device of claim 1, wherein the first nonce code data contains a coin value identifier associated with the subscriber device.

3. The device of claim 2, wherein the coin value identifier associated with the subscriber device is received from the distributed database devices.

4. The device of claim 3, wherein the coin value identifier associated with the subscriber device is received in response to sending an identifier associated with the subscriber device to the distributed database devices.

5. A method for mining coins, the method comprising: generating, from a communications network service provider and a hardware device, a resource expenditure corresponding to an active mobile station hardware, short messaging service, data and voice consumed by a subscriber, wherein the resource expenditure is given in terms of fiat money which is an input in an application software; transforming the resource expenditure into a number of coin identifier code; transforming the coin identifier codes into a number of digital currency coins; storing the digital currency coins in an off-line digital wallet.

6. The method according to claim 5, wherein the application software provides to the subscriber verifiable and secure information about resource expenditure and recorded in its intelligent database device as a wallet information.

7. The method according to claim 5, where a formula is used to transform the resource expenditure into the coin identifier code, the formula comprising: a difficulty level in generating the coin identifier codes, which is a given value of fiat money in a given country; one coin identifier value is equivalent to a ratio of the resource expenditure and the difficulty level.

8. The method according to claim 5, where a formula is used to transform the coin identifier code into digital currency coins, the formula comprising: a new difficulty level in generating the digital currency coins, which is the price of an amount of grains of pure gold; one digital currency coin value is equivalent to a ratio of the value of one participation point and the new difficulty level.

9. The method of claim 5, where transaction logs in the digital wallet is maintained by the coin network service provider, but the digital wallet is owned by the subscriber, who stores the digital wallet off-line.

10. The method of claim 5, wherein the distance between originator, who is a calling party and destination, who is a called party for data connectivity is taken to be within 30 km.

11. The method of claim 5, whereby if the destination is a called party, whether through data i.e. voice over internet protocol (VoIP) or circuit switched, the distance between the origin of calling party and destination of called party is computed as the distance between serving network cells or sectors within the network cells.

12. The method according to claim 10 and claim 11, where the distances are expressed in kilometers and converted into resource regime ratio, r.

13. The method according to claim 12, wherein the resource regime ratio, r is used to derive the average-expenditure for all calls based on the distance between the calling party and called party.

14. The method according to claims 1-13, wherein the mined digital currency coins are referred to as Layer type-A coins.

15. The method according to claim 14, wherein Layer type-A coins are used to mine Layer type-B coins by computing a valid hash value in a global network.

16. The method according to claim 15, where the valid hash value is computed by a subscriber node or mobile station using application software installed in the subscriber node.

17. The method according to claim 16, where the device of claim 1 that verifies a nonce code from a subscriber device is rewarded with an amount of layer type-B coin.

18. The method according to claim 17, where valid hash values are stored in a database and hash values are known by specified number of nodes in a global network.

19. A method of trading the digital currency coins of claim 5, wherein the digital currency coins are bought and sold at prices different from an amount of resource expenditure by the subscribers.

20. The method of claim 19, wherein the digital currency coins can be used for exchange of fiat money at a rate determined from the number of coin owners obtained after an initial coin offering when trading.

21. The method according to claim 19, wherein both Layer type-A coins and Layer type-B coins are traded as commodities in a secure exchange system.
